(19) United States
(12) Patent Application Publication
(10) Pub. No.: US 2026/0071855 A1
(43) Pub. Date: Mar. 12, 2026

(54) MOTORIZED VEHICLE FOR TARGET TRAINING

(71) Applicant: William G. THORNTON, Phoenix, AZ (US)

(72) Inventor: William G. THORNTON, Phoenix, AZ (US)

(21) Appl. No.: 19/322,202

(22) Filed: Sep. 8, 2025

Related U.S. Application Data
(60) Provisional application No. 63/691,508, filed on Sep. 6, 2024.

(51) Int. Cl. F41J 9/02; B60L 53/80; F41J 5/14; G05D 1/221; G05D 105/60

(52) U.S. Cl. CPC F41J 9/02; B60L 53/80; F41J 5/14; G05D 1/221; B60L 2200/00; G05D 2105/60

(57) ABSTRACT

An apparatus for target shooting includes a motorized carriage, a target mount configured to support a target, and a dummy that serves as the target for firearm projectiles. The carriage includes an assembly of metal and/or heavy duty plastic parts forming a frame, a motor box, and mounting surfaces and attachment points for the carriage electrical and electronic components and drive system. The drive system includes a motor mechanically connected to one or both of a front and rear axle, to which wheels are mounted. The drive system may include or be in signal communication with a wireless receiver or transceiver that receives control signals from a remote controller. The target mount may comprise metal members including a base member attached to the frame of the carriage, a pole attached to the base member and extending upward therefrom, and a mounting assembly attached at the top of the pole.

### CROSS REFERENCE TO RELATED APPLICATIONS

This application claims the benefit of priority to U.S. Provisional Application No. 63/691,508 filed on Sep. 6, 2024, the contents of which is incorporated herein by reference in its entirety.

### FIELD OF THE INVENTION

The present invention relates to motorized vehicles for target training.

### BACKGROUND

Target shooting is a popular activity for both recreational and professional purposes, including law enforcement and military training. Traditional target shooting setups often involve stationary targets, which can limit the realism and effectiveness of training exercises. Stationary targets do not adequately simulate real-world scenarios where targets may be moving or changing positions. This limitation can hinder the development of critical skills such as tracking moving targets, adjusting aim, and making quick decisions under pressure.

To address these challenges, there has been a growing interest in developing more dynamic and interactive target shooting systems. These systems aim to provide a more realistic training environment by incorporating moving targets that can simulate various scenarios. The use of motorized carriages and remote control mechanisms allows for greater flexibility and variability in target movement, enhancing the training experience. Additionally, integrating dummies as targets can provide a more lifelike representation, further improving the realism of the practice sessions. As the demand for more effective and realistic training tools continues to rise, innovations in target shooting apparatuses are becoming increasingly important.

### SUMMARY OF THE INVENTION

In accordance with embodiments, an apparatus for target shooting includes a motorized carriage, a target mount configured to support a target, and a dummy that serves as the target for firearm projectiles. The carriage includes an assembly of metal and/or heavy duty plastic parts forming a frame, a motor box, and mounting surfaces and attachment points for the carriage electrical and electronic components and drive system. The drive system includes a motor mechanically connected to one or both of a front and rear axle, to which wheels are mounted. The drive system may include or be in signal communication with a wireless receiver or transceiver that receives control signals from a remote controller. The target mount may comprise metal members including a base member attached to the frame of the carriage, a pole attached to the base member and extending upward therefrom, and a mounting assembly attached at the top of the pole. The mounting assembly includes attachment points that cooperate with attachment points on the dummy to mount the dummy on the target mount.

This Summary section is neither intended to be, nor should be, construed as being representative of the full extent and scope of the present disclosure. Additional benefits, features and embodiments of the present disclosure are set forth in the attached figures and in the description herein, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view of an example embodiment of a motorized vehicle for target training in accordance with the present disclosure;

FIG. 2 is a front perspective view of the vehicle of FIG. 1;

FIG. 3 is a top-front-right perspective view of an example embodiment of a chassis for a motorized vehicle for target training in accordance with the present disclosure;

FIG. 4 is a top-rear-left perspective view of the chassis of FIG. 3;

FIG. 5 is a top view of the chassis of FIG. 3;

FIG. 6 is a front view of the chassis of FIG. 3;

FIG. 7 is a rear view of the chassis of FIG. 3;

FIG. 8 is a right side view of the chassis of FIG. 3;

FIG. 9 is a top-front-right perspective view of the chassis of FIG. 3 with protective plating removed to illustrate internal structures;

FIG. 10 is a top-rear-left perspective view of the chassis of FIG. 9;

FIG. 11 is a bottom view of the chassis of FIG. 9;

FIG. 12 is a front view of the chassis of FIG. 9;

FIG. 13 is a perspective view of an example embodiment of a motor mount for a motorized vehicle for target training in accordance with the present disclosure;

FIG. 14 is a top perspective view of a front wheel assembly in a drive system for a motorized vehicle for target training in accordance with the present disclosure;

FIG. 15 is a top perspective view of a motor shield for a front wheel motor of a motorized vehicle for target training in accordance with the present disclosure;

FIG. 16 is a bottom perspective view of the motor shield of FIG. 15;

FIG. 17 is a perspective view of another example embodiment of a motor mount for a motorized vehicle for target training in accordance with the present disclosure;

FIG. 18 is a top perspective view of a rear wheel assembly in a drive system for a motorized vehicle for target training in accordance with the present disclosure;

FIG. 19 is a bottom perspective view of an example embodiment of an electronics mount for a motorized vehicle for target training in accordance with the present disclosure;

FIG. 20 is a top view of a motor controller box supported by the electronics mount of FIG. 19 within a chassis of a motorized vehicle for target training in accordance with the present disclosure;

FIG. 21 is the top view of FIG. 20 with the motor controller box opened to illustrate a motor control board in accordance with the present disclosure;

FIG. 22A representatively illustrates a battery mount for a battery for a drive system of a motorized vehicle for target training in accordance with the present disclosure

FIG. 22B illustrates a battery for use with the battery mount of FIG. 22A for a drive system of a motorized vehicle for target training in accordance with the present disclosure;

FIG. 23 is a perspective view of an example embodiment of a base for a dummy mount in accordance with the present disclosure;

FIG. 24 is a perspective view of an example embodiment of a dummy mount attached to a chassis of a motorized vehicle for target training in accordance with the present disclosure;

FIG. 25 is a perspective view of an example embodiment of a mounting platform for a dummy mount in accordance with the present disclosure;

FIG. 26 is a perspective view of an example embodiment of a handheld remote controller for a motorized vehicle for target training in accordance with the present disclosure;

FIG. 27 is a top-front-right perspective view of an alternative embodiment of a chassis for a motorized vehicle for target training in accordance with the present disclosure; and

FIG. 28 is a schematic diagram of the motorized vehicle in accordance with the present disclosure.

### DETAILED DESCRIPTION

The following detailed description describes embodiments of an electric motorized remote-controlled vehicle for target training, and is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

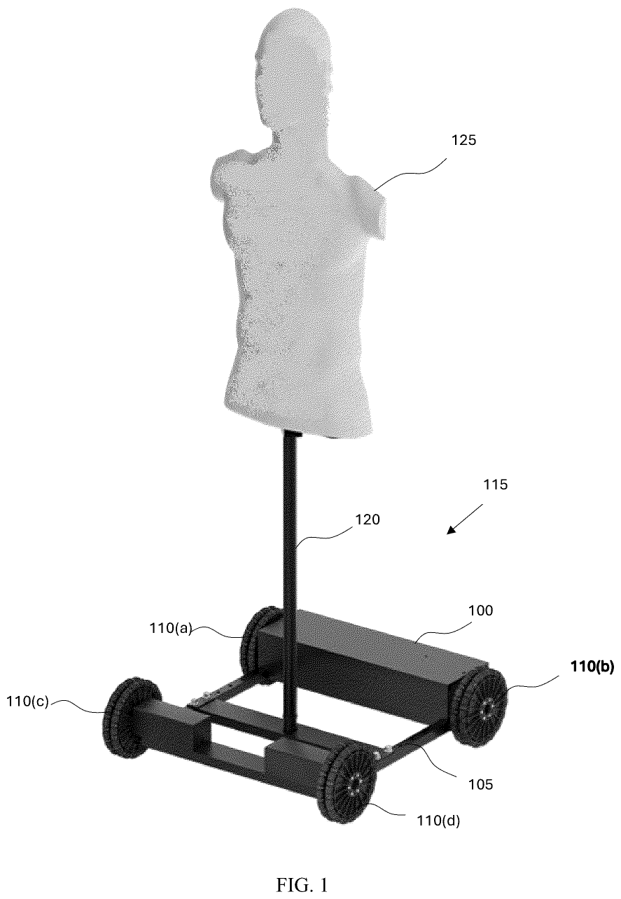

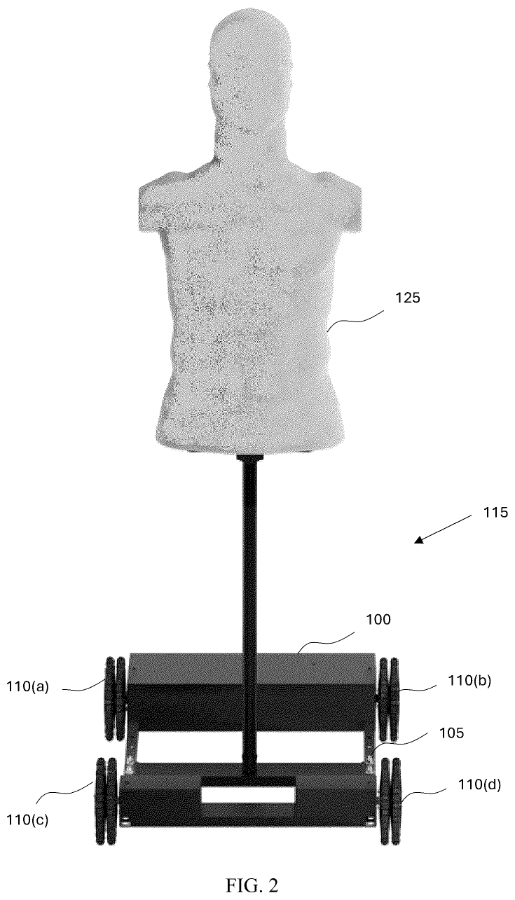

Reference will now be made in detail to example embodiments of the present invention, illustrated in the accompanying drawings. FIGS. 1 and 2 illustrate an example embodiment of a motorized vehicle 100 for target training. In particular, the vehicle 100 is optimized for use in live fire exercises associated with firearms training such as is provided to members of the military and law enforcement officers. The vehicle includes a chassis 105 that encloses and protects the electrical and electronic components of the vehicle 100, including elements of a drive system, a remote communication system, and a power supply chain. In some embodiments, the chassis 105 may be effectively “bulletproof,” which is to mean it is reasonably resistant to damage from bullets and similar projectiles, as well as from shrapnel and other high-velocity debris.

The vehicle 100 further includes wheels 110(a)˜110(d) rotatably mounted to the chassis 105. The wheels 110(a)˜110(d) may contact the terrain directly, or in some embodiments may support tires, track treads, and the like. In an example embodiment, the wheels 110(a)˜110(d) may be high-density or high-durability plastic; a more particular embodiment is illustrated, in which there are four sets of “dually” wheels (i.e., two distinct wheels separated by a rubber, plastic, or metal spacer) that are eight inches in diameter, and that are mounted to provide approximately two inches of ground clearance to the bottom of the chassis. In some embodiments the wheels 110(a)˜110(d) may be attached to a unitary drive train, or the front wheels may be attached to a front axle and the rear wheels to a rear axle, and either or both axles may be motorized. Such configurations provide for one-dimensional translation, forward or backward along a straight line. In other embodiments, such as described below, each of the wheels 110(a)˜110(d) may be independently motorized. This allows each wheel 110 to be rotated forward or backward at various speeds, or held stationary, relative to the other wheels. Given the appropriate drive signals, the vehicle in this configuration can turn (i.e., while moving forward or backward) and pivot (i.e., while at a standstill) in any direction.

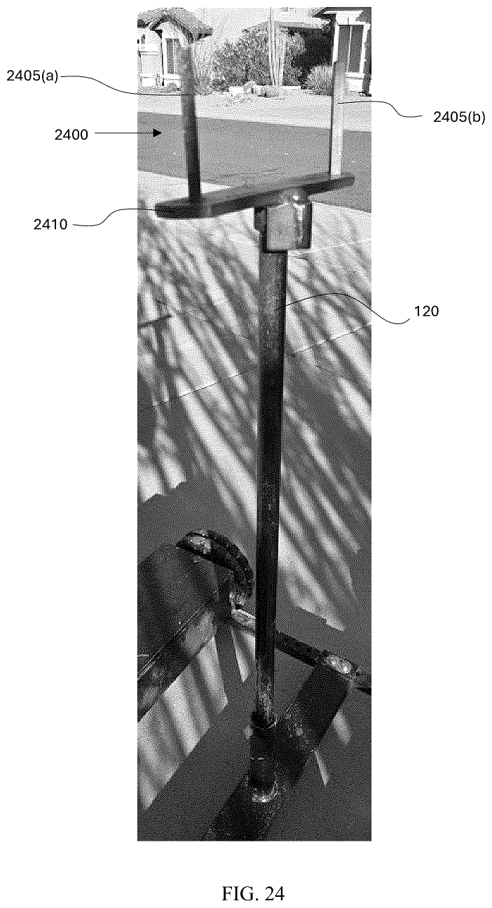

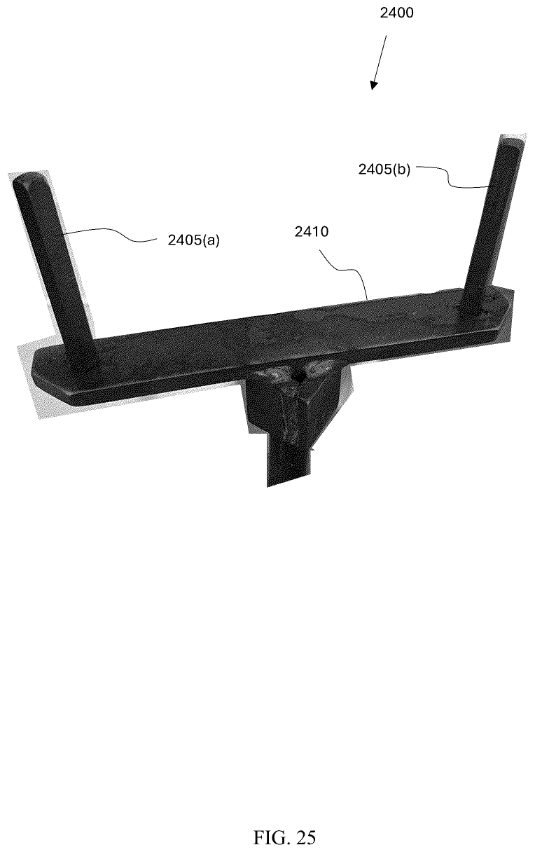

The vehicle 100 further includes a dummy mount 115 attached to or integral with the chassis 105. The dummy mount 115 includes a vertical bar 120 extending upward from the chassis 105 a suitable height for mounting a target dummy 125. A mounting platform 2400 (FIGS. 24-25) with a plurality of attachment members 2405(a), 2405(b) (FIGS. 24-25) for the target dummy 125 is attached to or integral with a bar 2410 at the top of the bar 2410. The target dummy 125 is then permanently or removably mounted on the mounting platform 2400. In embodiments, the target dummy 125 may have the shape of a human or a portion thereof, such as the torso and head of a human. In other embodiments, the target dummy 125 may have other shapes, such as an animal shape (i.e., for hunting practice) or a more typical shooting target shape. The illustrated example target training vehicle 100 is intended to mimic realistic emergency situations when an enemy is rapidly advancing on the trainee. Consequently, an example desirable dummy mount 115 configuration will position the target dummy 125 at a “typical” human height, for example positioning the top of the target dummy's head about six feet above the terrain; if an example target dummy 125 is about three feet in height, the vertical bar 120 of the dummy mount 115 may be 2.5-3 feet long and a base of the mounting platform 2400 (see FIGS. 24 and 25 and associated description) may be one to two inches thick.

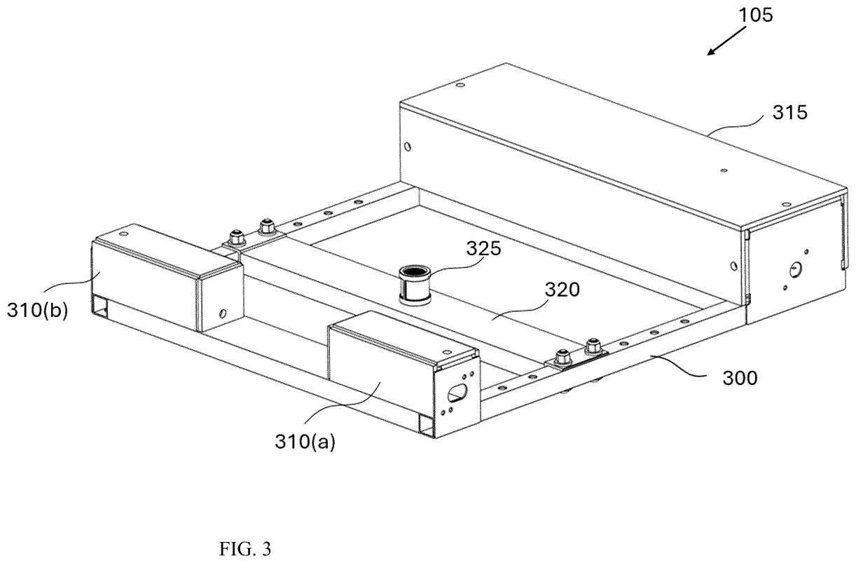

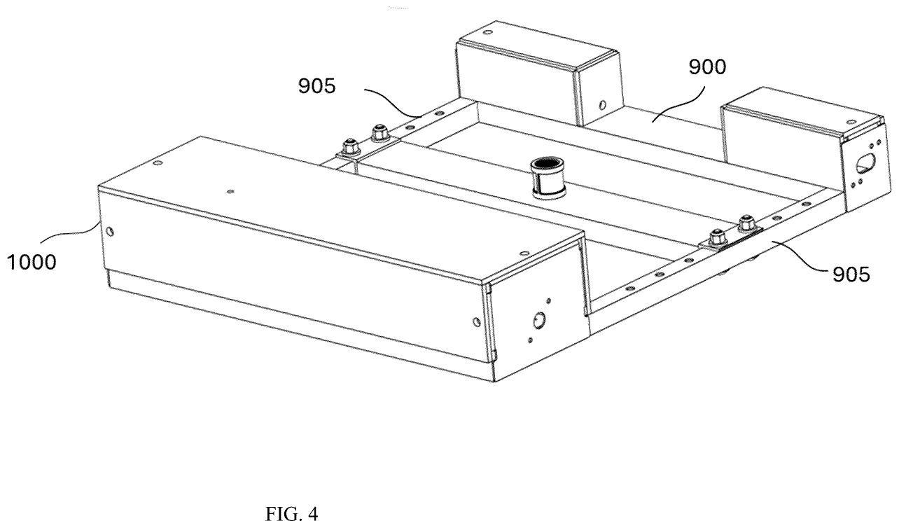

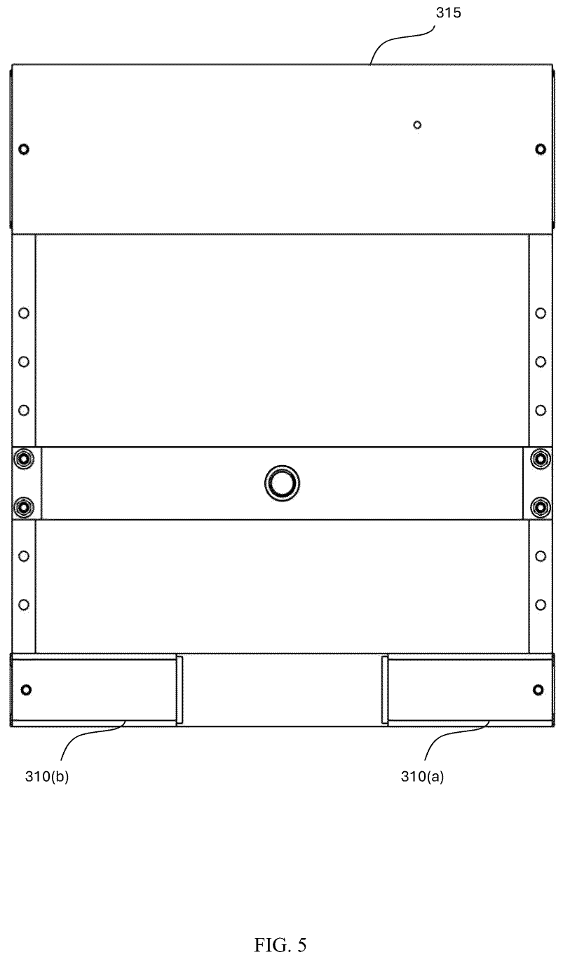

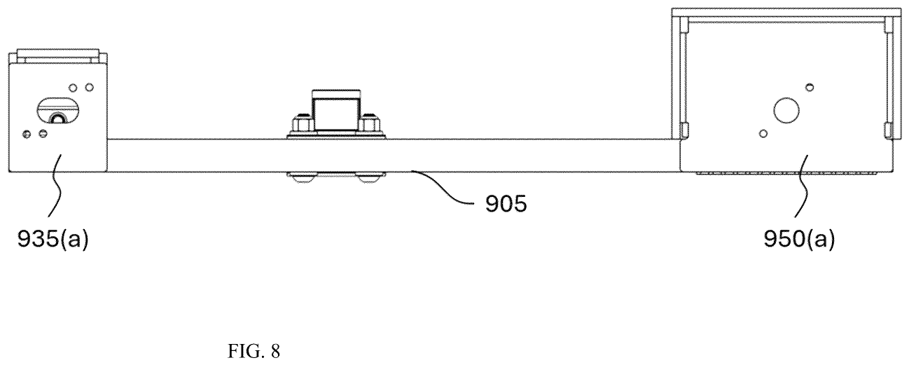

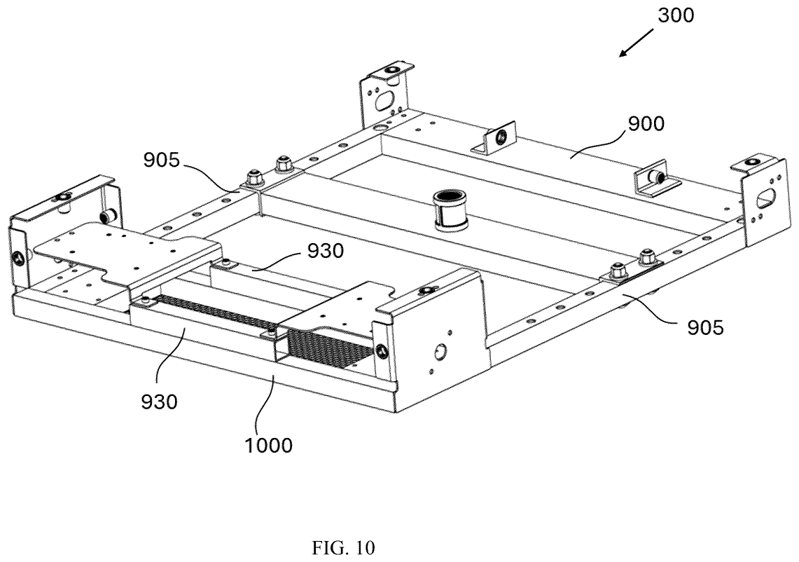

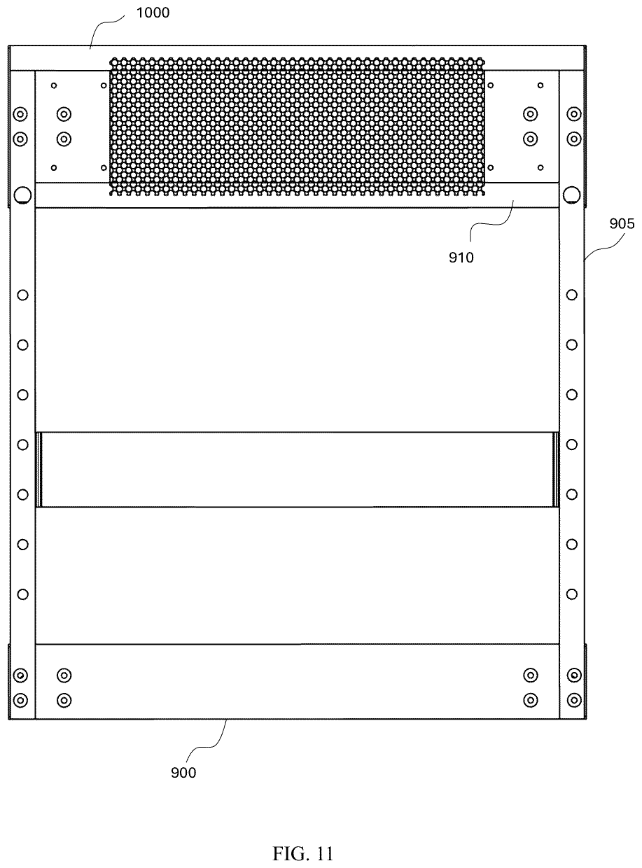

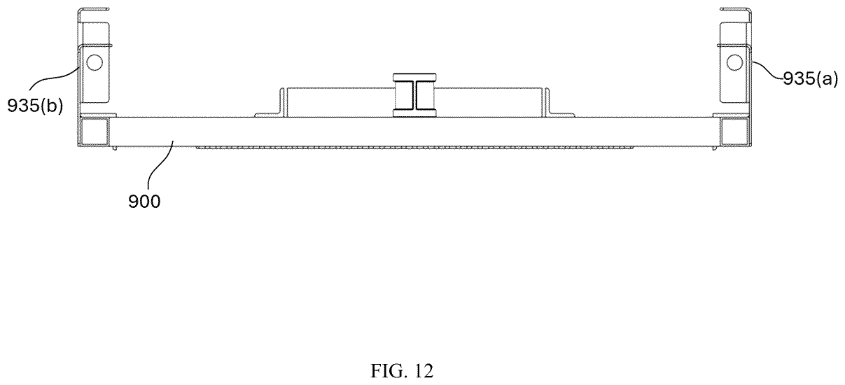

Referring to FIGS. 3-12, the chassis 105 of the motorized vehicle 100 may comprise a set of metal parts permanently (e.g., by welding or riveting) or removably (e.g., by screws, bolts, nuts, and/or other suitable fasteners) attached to each other to provide a frame 300, wheel mounts 305, electrical equipment compartments, and support for the dummy mount 115 of the vehicle 100. In various embodiments, the components of the frame 300 may be any metal of suitable weight and durability, including hardness and abrasion resistance. Examples include 14-16 gauge steel pipes and plates, abrasion resistance (e.g., AR400, AR500, and the like) steel plates, stamped sheet metal, plated steel (e.g., zinc-plated steel fasteners), graded steel, steel alloys (e.g., black-oxide steel), iron, aluminum, and the like.

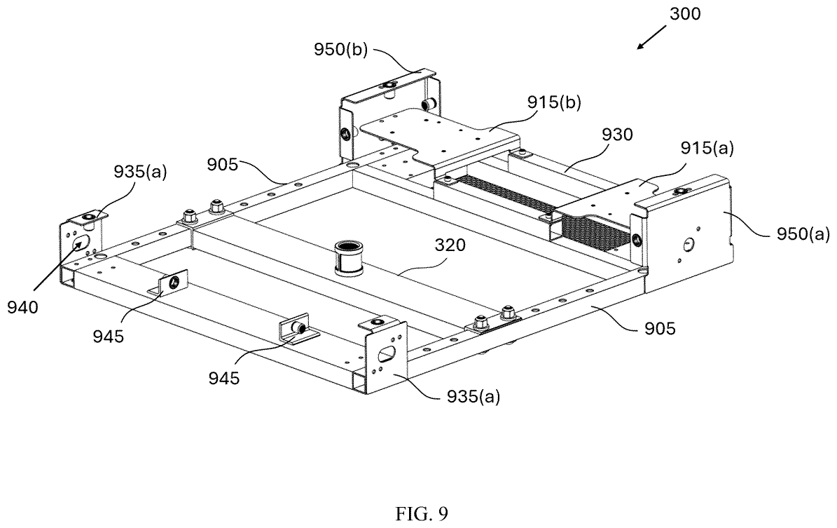

As shown in FIGS. 9-12, the chassis 105 may include a plurality of square and/or rectangular metal pipes or tubes interconnected to form the frame 300 of the chassis 105. The frame 300 may define the perimeter of the chassis 105. In the illustrated embodiment, the frame 300 is formed by a rectangular (e.g., 3 in.×1 in. tube) front member 900, square (e.g., 1 in. square tube), side members 905 attached to the ends of the front member 900 and extending rearward, and a square rear member 1000 attached to the distal terminal ends of the side members 905. The members of the frame 300 may be welded together or fastened by rivets, brackets, or similar fasteners. The frame 300 may further include one or more cross-members for stability and/or for support of other chassis components. For example, a first cross-member 910 may be a square tube attached to the side members approximate the rear wheels 110(a), 110(b) (FIG. 1). Additionally, the frame 300 may include left and right support members (not shown) attached at the inner surface of the respective left or right side member, between the rear member 1000 and the first cross-member 910. The support members may each be a rectangular (e.g., 3 in.×1in.) tube that serves as a motor mount for one motor 1400, of a plurality of motors, for the rear wheels, as described further below.

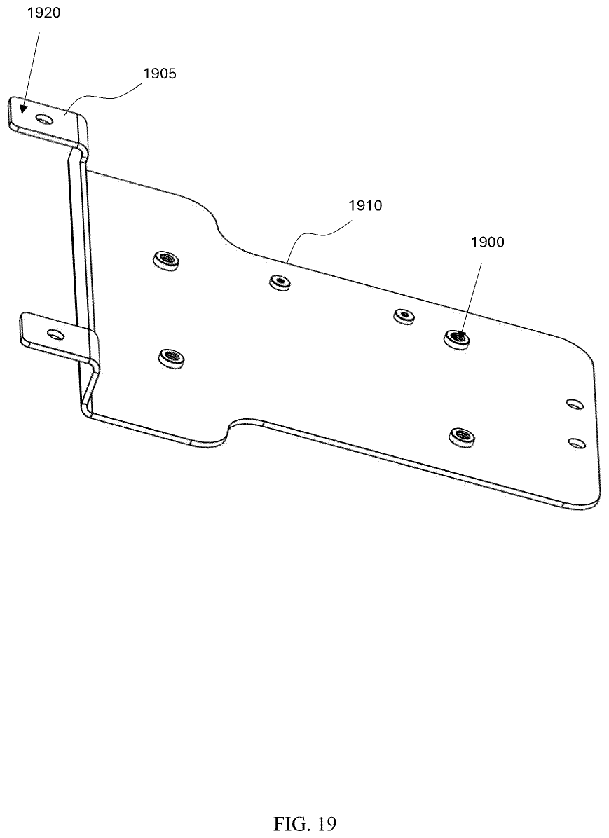

The chassis 105 may further include one or more electronics brackets attached to the frame 300 and configured to support mounting of electronics. As illustrated, a left electronics bracket 915(a) and a right electronics bracket 915(b) may be attached to bracket mounts 930, which may be square tubes attached to the rear member 1000 and the first cross-member 910 of the frame 300. Each electronics bracket 915(a), 915(b) extends over a respective support member of the frame 300, leaving space therebetween to accommodate one of the rear motors 1400, as described further below. An example electronics bracket 915 is illustrated in detail in FIG. 19. The electronics bracket 915 includes apertures 1900, which may be threaded or otherwise configured to receive fasteners that attach the respective electronic components to the bracket as described further below. The electronics bracket 915 may include bent tabs 1905 that extend vertically downward from a primary surface 1910, and then horizontal at the end; a horizontal portion 1920 receives a fastener to attach the bracket 915 to the bracket mounts 930. The tab 1905 serves to elevate the mounting surface of the electronics bracket 915 so that a motor 1400 fits underneath.

Referring again to FIGS. 3-12, the chassis 105 may further include motor brackets 935 for mounting the wheels 110 of the vehicle 100 to their respective motors 1400. Left and right front motor brackets 935(a), 935(b) may be attached to the respective side members of the frame at the front of the frame 300, as shown. Similarly, left and right rear motor brackets 950(a), 950(b) may be attached to the respective side members of the frame at the rear of the frame 300. Attachment of each motor bracket 935(a), 935(b), 950(a), 950(b) to the frame 300 may be by welding, adhesive, or suitable fasteners. One or more apertures 940 through each motor bracket 935(a), 935(b), 950(a), 950(b) may be aligned with an axle of the corresponding motor 1400, so that the axle extends out of the chassis 105 through the aperture 940; the corresponding wheel is then affixed to the axle to rotatably mount the wheel 110 to the chassis 105. Additional apertures in each bracket may receive fasteners for attaching the respective motor to the bracket and for attaching shielding plates to the bracket(s), as described further below.

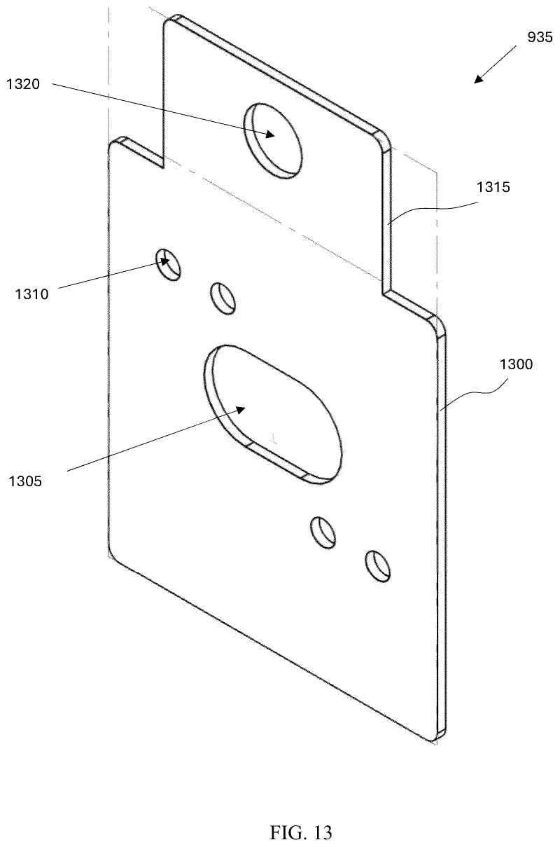

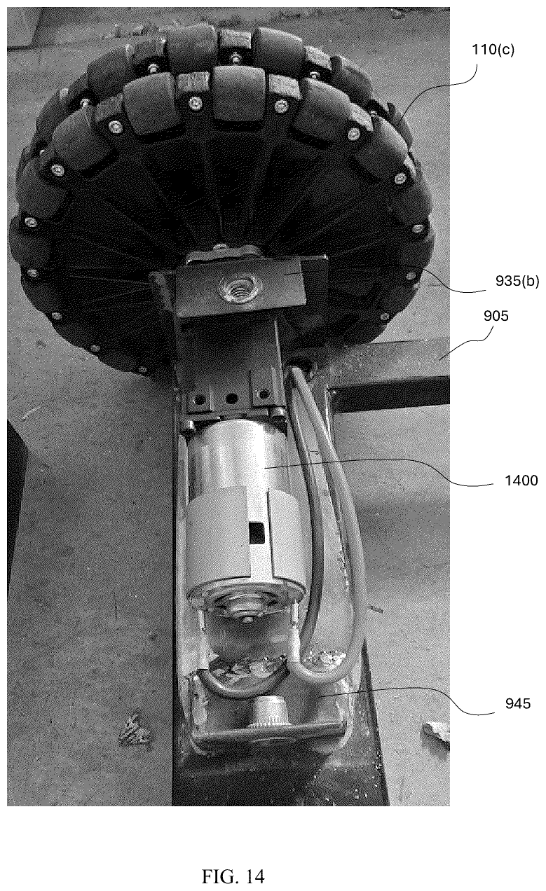

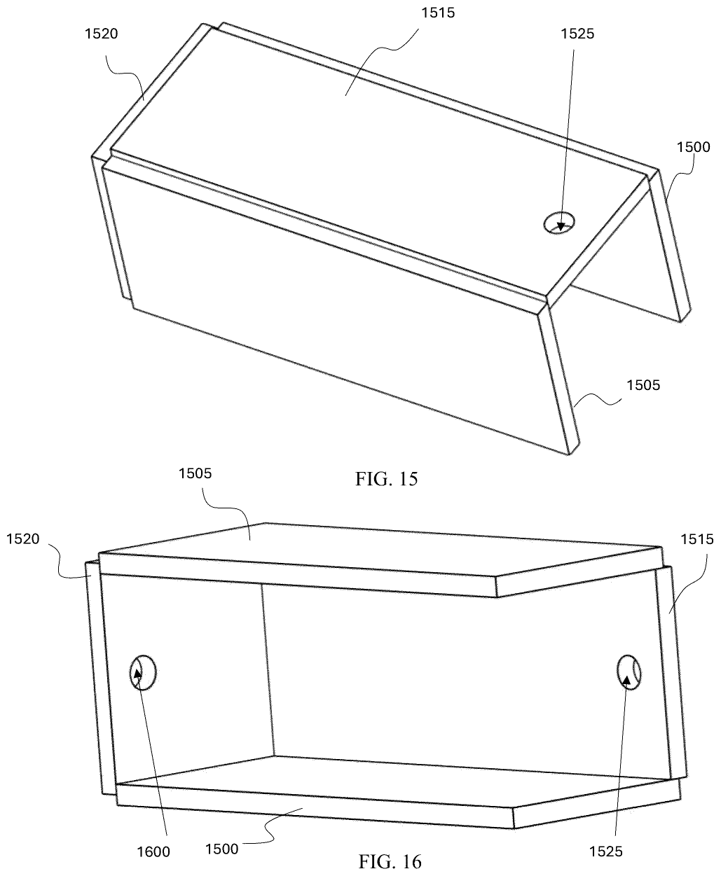

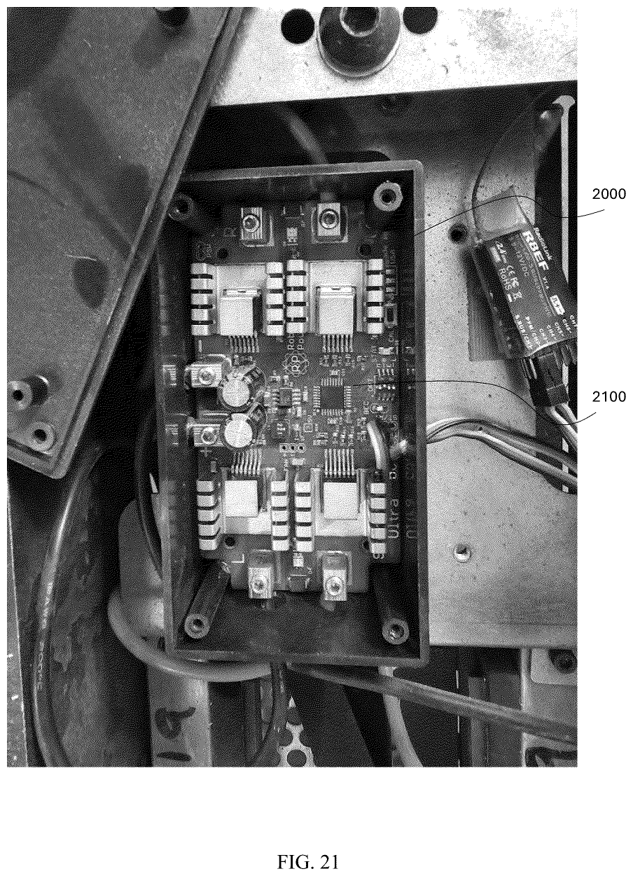

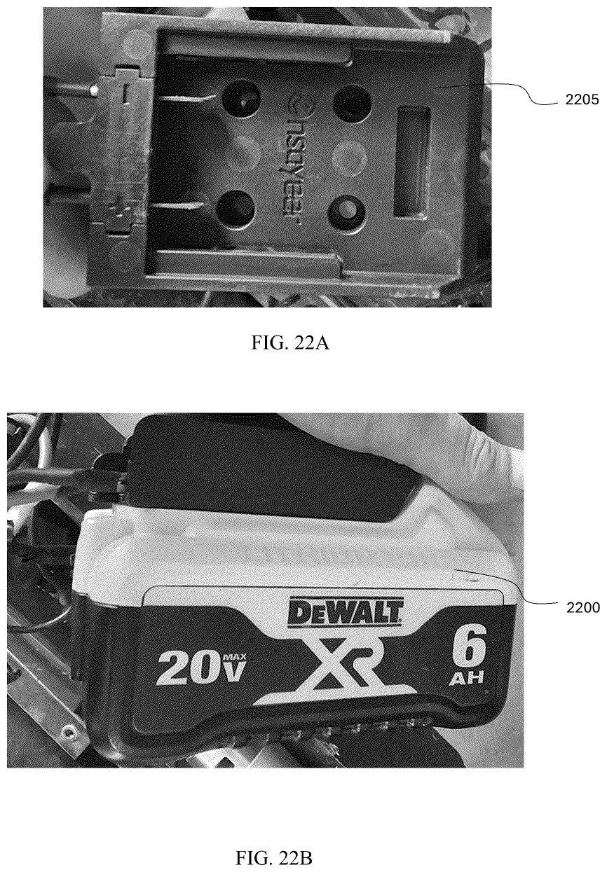

FIG. 13 illustrates an example stamped sheet metal front motor bracket 935. The front motor bracket 935 includes a body 1300 with a main aperture 1305 for receiving the motor axle and a plurality of fastener apertures 1310 for receiving screws or other fasteners that attach to the motor. A tab 1315 that is integral with the body 1300 extends upward from the body, and includes an aperture 1320 that receives a fastener for a motor shield 1500 (FIGS. 15 and 16) as described below. After stamping, the tab 1315 may be bent inward to a 90 degree angle with respect to the body. FIG. 14 shows an example installation of the vehicle drive system at the front right side. The drive system includes an electric motor 1400, such as a brushless direct current (DC) electric motor wired to a power supply 2200 (not shown, see FIG. 22B) and to a control system 2100 comprising a motor controller (not shown, see FIG. 21). The motor 1400 is affixed to the front motor bracket 935(a) inside the chassis 105, and a wheel 110(c) is attached to the axle of the motor 1400, which projects through the motor bracket 935(a) as described above. A steel rivet nut is seated within the corresponding aperture in the tab of the motor bracket. The rivet nut receives a matedly threaded bolt for attaching a motor shield that covers the depicted motor 1400. FIG. 14 further illustrates an angle bracket 945 attached to the frame distal of the motor 1400; the angle bracket 945 is one of a pair of opposite-facing angle brackets also shown in FIGS. 9, 10, and 12. These angle brackets 945 also each receive a rivet nut that receives a matedly threaded bolt for attaching the motor shield 1500.

FIGS. 15 and 16 illustrate the motor shield 310 for the front motors 1400. As shown in FIGS. 1-8, the example chassis 105 includes two motor shields 310(a), 310(b), one installed over each of the front motors. The motor shield 310 is an assembly of metal plates, preferably made of AR500 steel or similar abrasion-resistant metal. The assembly includes two rectangular side plates 1500, 1505 and a rectangular top plate 1515 have the same or approximately the same dimensions, and a square or rectangular end plate 1520. The plates are welded or otherwise adhered together. The top plate 1515 and end plate 1520 may have apertures 1525, 1600 that align with the respective attachment points on the chassis 105 (e.g., the tabs of the front motor brackets and the angle brackets attached to the front member of the frame) to affix the motor shield 310 to the frame over the respective motor 1400.

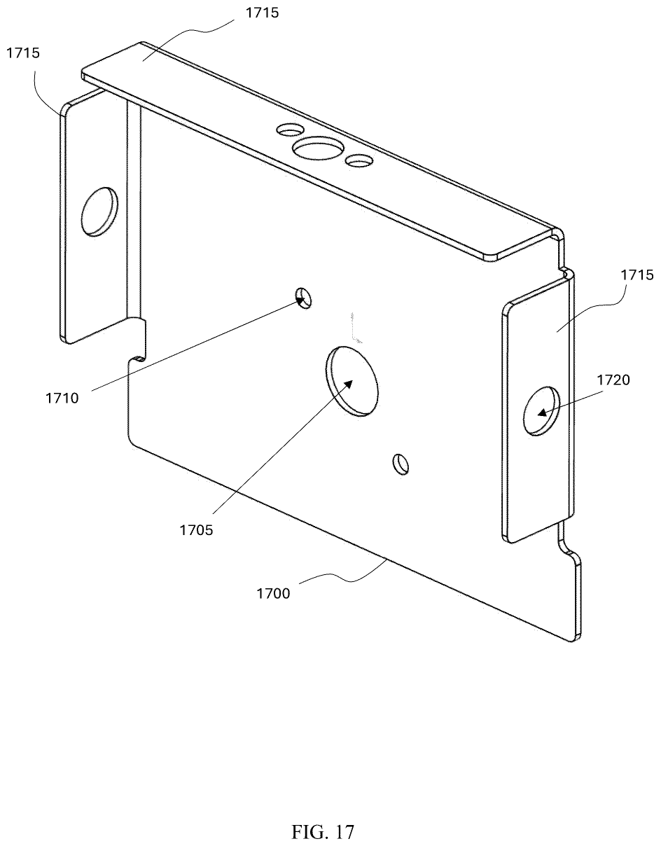

FIG. 17 illustrates an example stamped sheet metal rear motor bracket 950. The rear motor bracket 950 includes a body 1700 with a main aperture 1705 for receiving the motor axle and a plurality of fastener apertures 1710 for receiving screws or other fasteners that attach to the motor 1400. One or more tabs 1715 that are integral with the body extend away from the body, and each includes an aperture 1720 that receives a fastener for a corresponding side plate of a rear electronics compartment 315 as described below. After stamping, the tabs 1715 may be bent inward to a 90 degree angle with respect to the body 1700. For example, as illustrated, the rear motor bracket 950 may have three inwardly-extending tabs 1715 at the top and left and right edges of the body 1700.

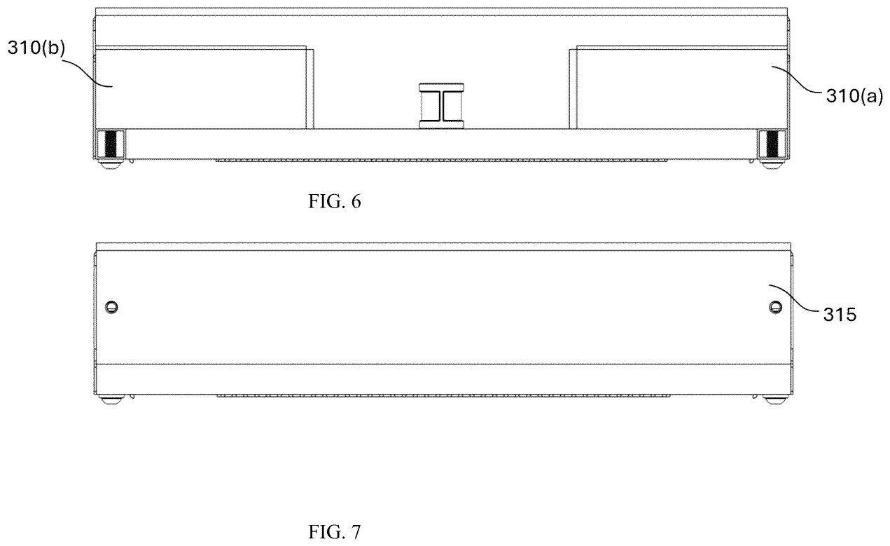

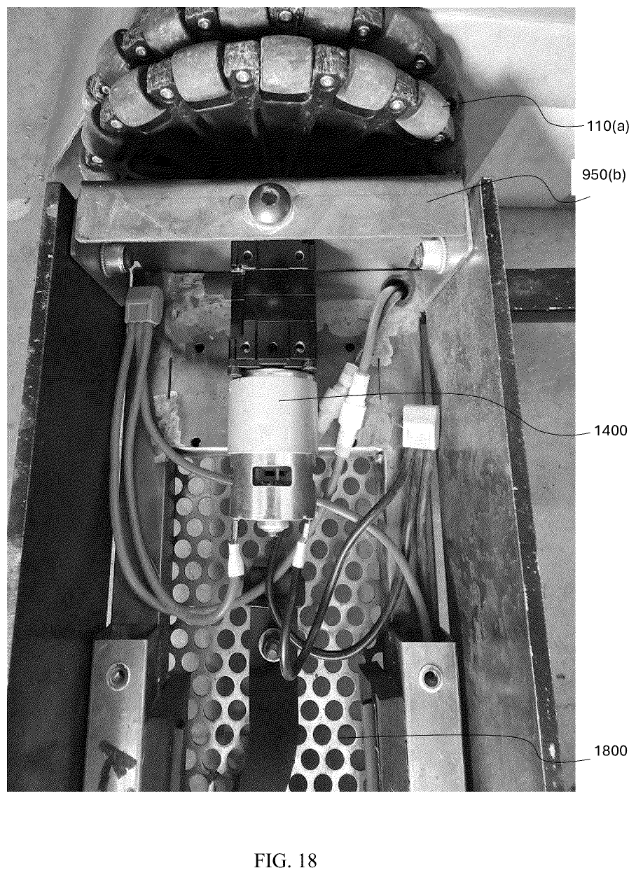

FIG. 18 shows an example installation of the vehicle drive system at the rear left side, with a top plate of the rear compartment removed. The rear left electric motor 1400 is wired to a power supply 2200 (not shown, see FIG. 22B) and to the control system 2100 (not shown, see FIG. 21). The motor 1400 is affixed to a rear motor bracket 950 inside the chassis, and a wheel is attached to the axle of the motor 1400, which projects through the motor bracket as described above. Steel rivet nuts are seated within the corresponding apertures in the tabs of the rear motor bracket, with the two “side” rivet nuts shown receiving matedly threaded bolts to attach a front plate and a rear plate of the rear compartment. Additionally, FIG. 18 shows a protective grate 1800 of the chassis 105 (also visible in FIGS. 6-12 and 20) installed below the frame 300 to substantially enclose the rear compartment 315 and protect the enclosed electronics from debris.

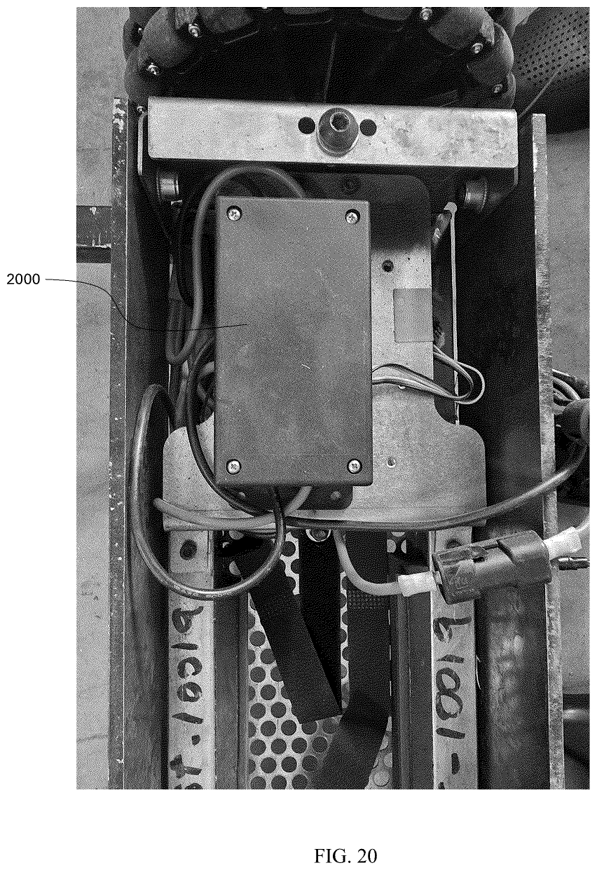

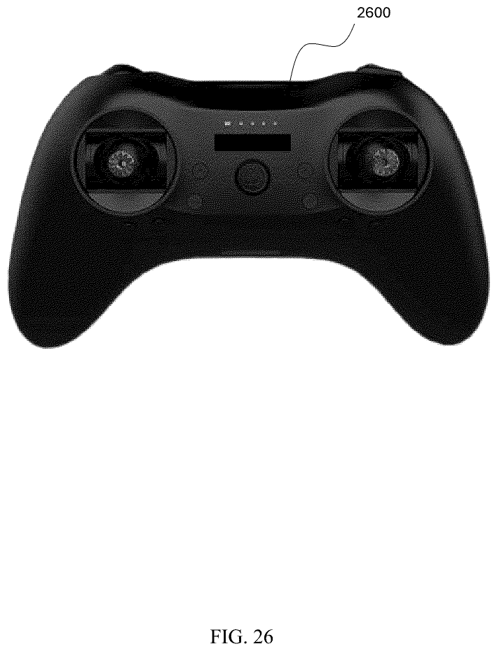

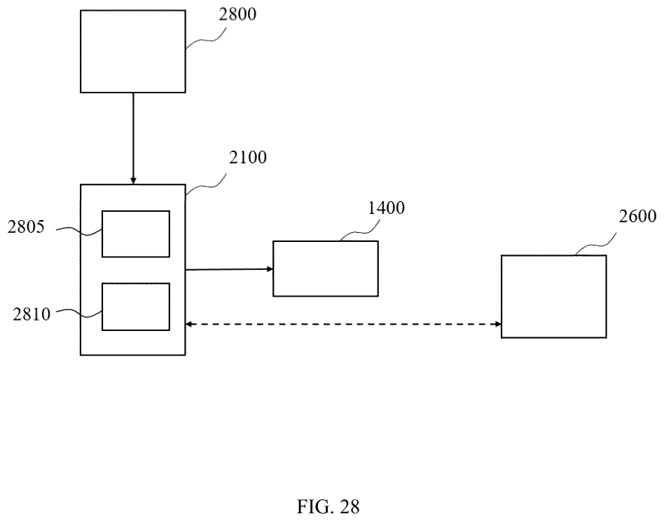

The left side electronics bracket 915(b) described above with respect to FIGS. 9, 10, and 19 is further illustrated in FIGS. 20 and 21 with a motor controller box 2000 mounted thereon. The right side electronics bracket 915(a) supports the power supply 2200, such as a battery and battery adapter 2205 as depicted in FIGS. 22A-22B. The motor controller box 2000 may be a plastic or other suitable housing that encloses and protects a motor controller 2100. The control system 2100 is electrically connected to the power supply 2200, and receives an electric current from the power supply 2200 and delivers the electric current to one or more of the motors 1400 as prescribed by control signals. The control system 2100 is in signal communication with a wireless communication system 2810 (FIG. 28), such as a wireless receiver or transceiver, to receive the control signals. The communication system 2810 in turn is in signal communication with a remote device, such as the handheld controller 2600 of FIG. 26. Various communication protocols, such as radio frequency, Bluetooth, and TCP/IP, are contemplated; for example, the wireless signals may be in the 2.4 GHz band. The control system 2100 receives the control signals and decodes them to determine the supply of power and the rotational direction of each motor 1400, and then controls the speed and direction of each motor 1400 accordingly. The battery may be any suitable battery for a remotely operated vehicle, and may be rechargeable by either removing the battery and plugging it into a charger, or by connecting a charger to a charging port (not shown) of the vehicle.

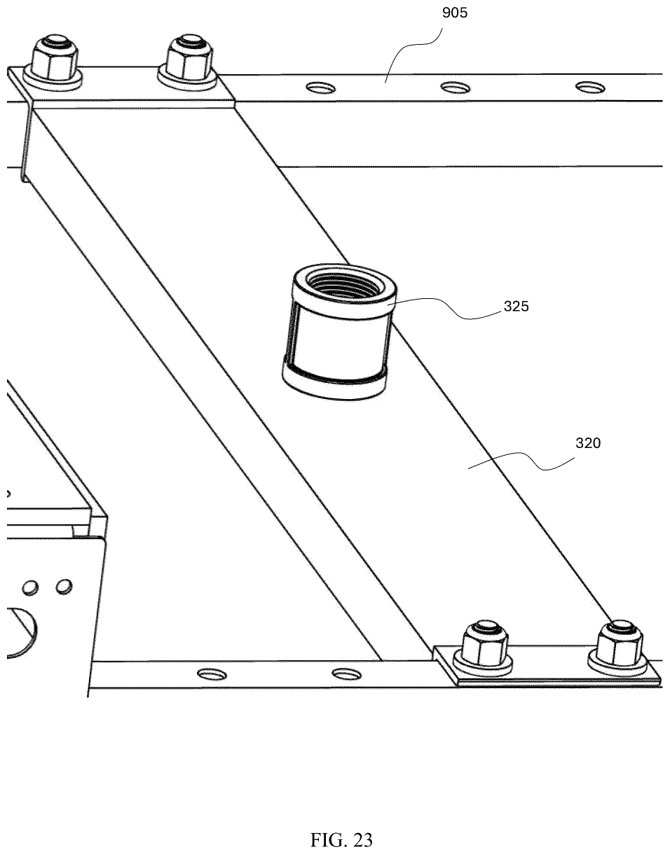

The dummy mount 115 may be attached to the chassis 105. Referring to FIGS. 23 and 24, the dummy mount 115 may include a base 320, such as a crossbar 320 attached to the chassis 105 (as also depicted in FIGS. 1-12). For example, the base 320 may be a rectangular tube including an angle bracket at each end, the angle brackets having apertures that align with apertures in the left and right side members of the frame; the base 320 may thereby be bolted to the frame as shown. The base 320 may further include a support member 325, such as a cylindrical stand, that receives a post or bar of the dummy mount 115. In some embodiments, the support member 325 may be a galvanized iron pipe fitting that is welded to the base 320 and is matedly threaded with the end of the pole 120. The pole 120 then extends vertically as described above, and at its terminal end is attached to or integral with a mount 2400 that includes a base 2410 and one or more attachment members 2405(a), 2405(b) that cooperate with the dummy 125 to mount the dummy 125. Referring to FIG. 25, the base 2410 of the mount 2400 may be welded to the pole 120, and the attachment members 2405(a), 2405(b) include two steel or iron bars approximate opposite ends of the base and extending upward 18 to 24 inches. The dummy 125 (see FIGS. 1 and 2) may be made of a ballistic material with channels that are aligned with the attachment members 2405(a), 2405(b) and extend inward from the bottom of the dummy 125.

In various embodiments, and referring to FIGS. 1 and 28, the vehicle 100 may further comprise a sensor system 2800 embedded within the dummy 125 to detect direct impacts (e.g., by a firearm projectile) to the dummy 125. For example, the sensor system 2800 may comprise an acoustic sensor, capacitive sensors, ultrasonic sensors, accelerometers, force-sensitive resistors, piezoelectric sensors, shock sensors, or the like. The sensor system 2800 may be electrically coupled to and transmit a signal to the control system 2100 indicating a direct impact (or hit) to the dummy 125. The control system 2100 may then transmit an indicator signal to the remote device 2600 to provide an indication to the user of a successful impact. The sensors of the sensor system 2800 may be located on any area of the dummy 125, and in some cases may be arranged to detect impacts to specific areas of the dummy 125, such as the head and upper chest area where a lethal impact may occur. In some embodiments, the sensor system 2800 may be electrically connected to the control system 2100. In other embodiments, the sensor system 2800 may be wirelessly connected to the control system via a wireless communication protocol.

In various embodiments, the control system 2100 may be arranged within the chassis 105, such as within an electrical compartment. The control system 2100 may be configured to receive and transmits various signals. For example, the control system 2100 may receive impact signals from the sensor system 2700 and transmit the impact signal to the remote device 2600. In some embodiments, the control system 2100 may comprise a microcontroller to control the motors 1400. In some embodiments, the control system 2100 may comprise a programmable controller with a memory 2705 to store a predetermined movement pattern. The control system 2100 may then transmit control signals to the motors 1400 to move the vehicle 100 according to the predetermined movement pattern. In this case, the vehicle 100 moves autonomously.

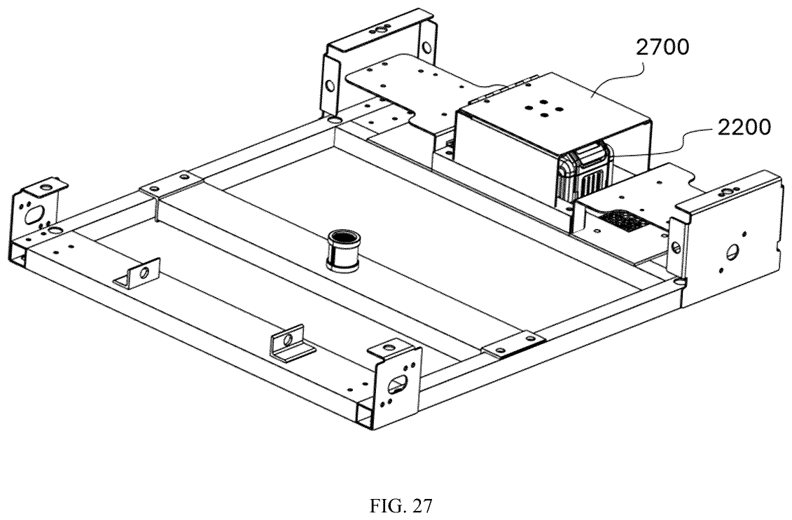

In various embodiments, and referring to FIG. 27, the chassis 105 may further comprise a protective housing 2700 to house or otherwise enclose the power supply 2200. The protective housing 2700 may comprise an assembly of metal plates, preferably made of AR500 steel or similar abrasion-resistant metal. A top plate of the protective housing 2700 may be attached to a wall plate by a hinge or other fastener for access to the interior portion of the housing 2700.

In embodiments, the presently described motorized vehicle for target training, when fully assembled and fully charged, may be configured to move smoothly over both indoor and outdoor terrains and to approximate the speed of the represented target (e.g., up to about 22 mph with a human-shaped dummy attached). For durability, the abrasion-resistant shielding may be powder-coated, anodized, etc. In an example embodiment, the length and width of the vehicle base (i.e., the assembled chassis and drive system) may be about 28 to 34 inches; further examples include a front track of about 28 inches, a rear track of 28 to 30 inches, and a wheelbase of 22 to 30 inches. A wheel diameter of eight inches provides about two inches of clearance for the bottom of the chassis.

An example suitable power supply 2200 is a 6 Ah or 8 Ah 20 volt lithium-ion battery. An example suitable motor 1400 for the four drive motors is a 24 volt RS775 electric motor, with a half-inch diameter hex-shaped axle. Each motor 1400 may be equipped with a gearbox including planetary gears with suitable gear ratios. An example suitable motor controller 2100 is the SCORPION ULTRA dual motor controller from ROBOT POWER, housed in an ABS motor controller box. A suitable example wireless communication system 2810 is the R8EF transceiver by RADIOLINK.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalent.

1. An apparatus, comprising:
a chassis comprising:
a frame comprising a plurality of structural interconnects;
a drive system attached to the frame and comprising:
a first axle rotatably mounted to the frame;
a second axle rotatably mounted to the frame and arranged opposite to and in parallel with the first axle;
a control system enclosed within a housing mounted to the frame; and
a motor electrically connected to and responsive to the motor controller, and mechanically coupled to the first and second axles;
a plurality of wheels mounted to each of the first axle and the second axle; and
a target mount comprising:
a base member coupled to the frame;
a pole comprising a first end attached to the base member, and extending upwards from and perpendicular to the frame; and
a mounting assembly coupled to a second end of the pole.

2. The apparatus according to claim 1, wherein the mounting assembly further comprises a first plurality of attachment points that cooperate with a second plurality of attachment points on a target.

3. The apparatus according to claim 2, further comprising a sensor system embedded within the target, wherein the sensor system detects direct impacts to the target.

4. The apparatus according to claim 3, wherein the control system is in communication with the sensor system, and transmits an impact signal to a remote device.

5. The apparatus according to claim 1, wherein the control system further comprises a communication system to receive a control signal from a remote device.

6. The apparatus according to claim 5, wherein the control system is responsive to the control signal.

7. The apparatus according to claim 1, further comprising a power supply removably attached to the chassis, and electrically coupled to the motor controller.

8. The apparatus according to claim 1, wherein the control system comprises a programmable controller for storing a predetermined movement pattern, and the programmable controller operates the motors according to the predetermined movement pattern.

9. An apparatus responsive to a remote device, comprising:
a motorized chassis comprising:
a frame;
a wireless communication system to receive a control signal from the remote device; and
a plurality of wheels rotatably attached to the frame and responsive to a motor and a control system, wherein the control system is in communication with the wireless communication system;
a power supply removably attached to the motorized chassis, and electrically coupled to the motor controller;
a target mount attached to and extending upwards from and perpendicular to the frame; and
a target removably attached to the target mount.

10. The apparatus according to claim 9, further comprising a sensor system embedded within the target, wherein the sensor system detects direct impacts to the target.

11. The apparatus according to claim 10, wherein the control system is in communication with the sensor system, and transmits an impact signal to a remote device.

12. The apparatus according to claim 9, wherein the target mount comprises:
a base member coupled to the frame;
a pole comprising a first end attached to the base member, and extending upwards and perpendicular to the frame; and
a mounting assembly coupled to a second end of the pole.

13. The apparatus according to claim 12, wherein the mounting assembly further comprises a first plurality of attachment points that cooperate with a second plurality of attachment points on a target.

14. The apparatus according to claim 9, wherein the control system is enclosed within a housing mounted to the frame.

15. The apparatus according to claim 9, wherein the motorized chassis further comprises a drive system attached to the frame and comprising:
a first axle rotatably mounted to the frame; and
a second axle rotatably mounted to the frame and arranged opposite to and in parallel with the first axle, wherein at least two wheels from the plurality of wheels are mounted to each of the first axle and the second axle.

16. An apparatus, comprising:
a motorized chassis comprising:
a frame; and
a plurality of wheels rotatably attached to the frame, each wheel responsive to a respective motor from a plurality of motors and a control system;
a power supply removably attached to the motorized chassis, and electrically coupled to the motor controller;
a target mount attached to and extending upwards from and perpendicular to the frame; and
a target removably attached to the target mount.

17. The apparatus according to claim 16, further comprising a sensor system embedded within the target, wherein the sensor system detects direct impacts to the target.

18. The apparatus according to claim 17, wherein control system is in communication with the sensor system, wherein the control system transmits an impact signal to a remote device via a wireless communication protocol.

19. The apparatus according to claim 16, wherein the control system comprises a programmable controller for storing a predetermined movement pattern, and wherein the motor controller is electrically coupled to the programmable controller and operates according to the predetermined movement pattern.

20. The apparatus according to claim 16, wherein the control system comprises a communication system to receive a control signal from a remote device via a wireless communication protocol.
